(19) United States
(12) Patent Application Publication
(10) Pub. No.: US 2009/0024499 A1
(43) Pub. Date: Jan. 22, 2009

(54) DISPLAYS CONTAINING FLAGGED DATA

(75) Inventor: Robert Harry Ribble, Santee, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/781,120

(22) Filed: Jul. 20, 2007

(51) Int. Cl. G06Q 40/00; G06F 17/30

(52) U.S. Cl. 705/35

(57) ABSTRACT

Tools to provide visibility into a variety of financial transactions, and in particular aspects, financial transactions involving financial cards, such as debit cards and credit cards. Such tools can allow for authorized users (such as executives of card issuers, and the like) to view information about accounts that meet certain criteria. Merely by way of example, a user can select accounts that have undertaken (or attempted) a certain type of transaction and/or have had a transaction denied (such as a denial for improper PIN, exceeding withdrawal and/or spending limits, etc.) and/or view additional information about those accounts.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The present invention relates, in general, to processing financial data, and more particularly, to tools for allowing a user to view data about financial transactions and accounts.

### BACKGROUND

On a daily basis there are millions of financial transactions (including, without limitation, credit card transactions and/or debit card transactions) processed on behalf of consumers and card issuing institutions. A portion of these result in transaction activity that is not successful for a variety of reasons.

The challenge facing the business community is the identification of significant areas that require immediate attention as well as identifying the consumers impacted by the events. Merely by way of example, if a customer is faced with a transaction denial for exceeding daily transaction limits (either in terms of the number of transactions or the dollar value of the transactions), that event potentially can cause customer dissatisfaction, and eventually could provoke the customer to select another card issuer or financial institution. Accordingly, it would be beneficial if there were facilities to allow a card issuer (and, more particularly, a decision-maker at a card issuer) to quickly identify such situations. Currently, however, there are no suitable tools that provide a card issuing institution with visibility into such areas.

### BRIEF SUMMARY

In an aspect, embodiments of the invention provide visibility into a variety of financial transactions, and in particular aspects, financial transactions involving financial cards, such as debit cards and credit cards. Beneficially, this visibility can allow for authorized users (such as executives of card issuers, and the like) to view information about accounts that meet certain criteria. Merely by way of example, a user can select accounts that have undertaken (or attempted) a certain type of transaction and/or have had a transaction denied (such as a denial for improper PIN, exceeding withdrawal and/or spending limits, etc.) and/or view additional information about those accounts. This visibility can provide the basis of enhanced decision making (such as deciding to increase withdrawal and/or spending limits, etc.).

The tools provided by various embodiments of the invention include, without limitation, methods, systems, and/or software products. Mainly by way of example, a method might comprise one or more procedures, any or all of which are executed by a computer system. Correspondingly, an embodiment might comprise a computer system configured with instructions to perform one or more procedures in accordance with methods of the invention. Similarly, a computer program might comprise a set of instructions that are executable by a computer system (and/or a processor therein) to perform such operations. In many cases, such software programs are encoded on physical and/or tangible computer readable media (such as, merely by way of example, optical media, magnetic media, and/or the like). In a particular embodiment, the set of instructions might be incorporated within an enterprise application and/or might be provided as a separate computer program that can be used to configure the enterprise application.

Merely by way of example, one set of embodiments provides methods. A method of providing access to data about usage of financial instruments, in accordance with one embodiment, comprises maintaining a database comprising a plurality of records pertaining to a plurality of transactions involving a plurality of financial accounts. In an aspect, each financial account may be associated with a financial instrument (such as a debit card, credit card, prepaid cards, home equity line of credit cards, etc.). The plurality of records might comprise a first record pertaining to a first transaction involving a first financial instrument, and a second record pertaining to a second transaction involving a second financial instrument.

In some embodiments, the method further comprises providing a user interface for a user to view data about the plurality of transactions and/or receiving (e.g., via the user interface) a selection of a type of transaction. The database may be accessed, for example, to obtain a set of data for the selected type of transaction. The method, in an aspect, can include providing for the user interface to display, for the user, information about one or more transactions of the selected type. In another aspect, the one or more transactions comprises the first transaction.

The method, then, might comprise receiving (again, perhaps via the user interface) a request to view additional detail about the first transaction and/or providing for the display, in response to the selection of one or more transaction detail entries, of a set of account information about the first financial account.

Optionally, the tools of the invention may be configured to allow a user to “drill down” into a set of transactions to select a transaction for which the user would like to view details. Merely by way of example, in some cases, the method may comprise receiving, via the user interface, a selection of a type of transaction and/or a selection of a period of interest; the method then might further comprise accessing the database to obtain a set of data for the selected type of transaction and/or the selected period of interest, and providing for the user interface to display, for the user, a plurality of transaction summaries, In an aspect, the plurality comprises a first transaction summary and a second transaction summary. Merely by way of example, the first transaction summary might displaying summary data about a first set of transactions occurring within a first subperiod of the selected period of interest, and/or might comprise a plurality of fields that display aggregate data about the first set of transactions.

Further, the method may comprise receiving a selection of the first transaction summary and/or generating, based on the selection of the first transaction summary, a query of the database for records pertaining to transactions of the selected type that occurred within the first subperiod. The method might also comprise providing, in response to the selection of the first transaction summary, for the user interface to display of a set of results of the query. In an aspect, the display of the set of results comprises a display of a plurality of transaction detail entries, each of which pertains to one of the transactions in the first plurality of transactions (this plurality of transactions might comprising the first transaction). A selection of one or more of the transaction detail entries may be received (e.g., via the user interface), and account information about the accounts associated with these transaction(s) can be displayed, as indicated above.

As noted above, other embodiments provide systems and/or computer programs. An exemplary system, for example, comprises a database, which might comprise a plurality of records pertaining to a plurality of transactions involving a plurality of financial accounts, each financial account having associated therewith a financial instrument. The plurality of records might comprises a first record pertaining to a first transaction involving a first financial instrument and/or a second record pertaining to a second transaction involving a second financial instrument.

The system, in an aspect, further comprises one or more processors in communication with the database, and a computer readable storage medium having encoded thereon a computer program. The computer program might comprise a set of instructions executable by the processor to perform a set of operations. Merely by way of example, the set of instructions, in an embodiment, comprises instructions executable by the computer to perform methods of the invention (and/or portions of such methods). The computer program itself is yet another embodiment of the invention.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral to denote one of multiple similar components. When reference is made to a reference numeral without specification to an existing sublabel, it is intended to refer to all such multiple similar components.

FIG. 1A is a process flow diagram illustrating a method of providing access to data about the usage of financial instruments, in accordance with various embodiments of the invention.

FIG. 1B is a process flow diagram illustrating a method of selecting a set of information to display, in accordance with various embodiments of the invention.

FIGS. 2-5 are exemplary screen displays illustrating user interfaces for providing access to data about the usage of financial instruments, in accordance with various embodiments of the invention.

FIG. 6 is a generalized schematic diagram illustrating a computer system, in accordance with various embodiments of the invention.

FIG. 7 is a block diagram illustrating a networked system of computers, which can be used in accordance with various embodiments of the invention.

### DETAILED DESCRIPTION OF THE INVENTION

While various aspects of the invention have been summarized above, the following detailed description illustrates exemplary embodiments in further detail to enable one of skill in the art to practice the invention. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Several embodiments of the invention are described below, and while various features are ascribed to different embodiments, it should be appreciated that the features described with respect to one embodiment may be incorporated with another embodiments as well. By the same token, however, no single feature or features of any described embodiment should be considered essential to the invention, as other embodiments of the invention may omit such features.

In a novel aspect, some embodiments of the invention provide a user (who may be, for example, an executive of a card issuer) with the ability to view details about one or more debit cards, credit cards, or other financial instruments, based on transactions (or attempted) transactions that users of those cards engaged in, and/or based on various other criteria. Advantageously, such embodiments allow a card issuer to quickly identify card accounts in need of attention. Merely by way of example, an embodiment of the invention can allow a user to identify cardholders who have not activated cards and/or to initiate a communication with such a cardholder (e.g., to encourage the cardholder to activate the card, to inquire whether the cardholder would prefer to close the card account, etc.).

Similarly, in another embodiment, the tools of the invention can allow a user to identify card accounts that have recently had a transaction denied for a particular reason, and/or to remedy the condition that caused the denial, if desired. For instance, the tools of the invention can be configured to allow a user to identify a card account that had a transaction denied for exceeding a daily limit, and, if desired, take corrective action to raise the daily limit to prevent future denials of this type. Hence, in one aspect, embodiments of the invention can provide card issuers, processors, etc. with the ability to provide enhanced customer satisfaction by responding to conditions that often evidence, or lead to, customer dissatisfaction, allowing the issues, processors, etc. to take a proactive approach to customer satisfaction.

Although the examples provided in this detailed description refer primarily displaying information about financial card accounts (i.e., accounts that are associated with a credit card, a debit card, a prepaid card, a home equity line of credit (“HELOC”) card, and/or the like), it should be appreciated that embodiments of the invention are not limited to accounts associated with such cards, but instead may be implemented with respect to any sort of financial account with which transactions are performed. Such accounts can include, in addition to card accounts, other types of accounts, such as depository accounts, accounts associated with stocks, mutual funds and/or other securities, and the like.

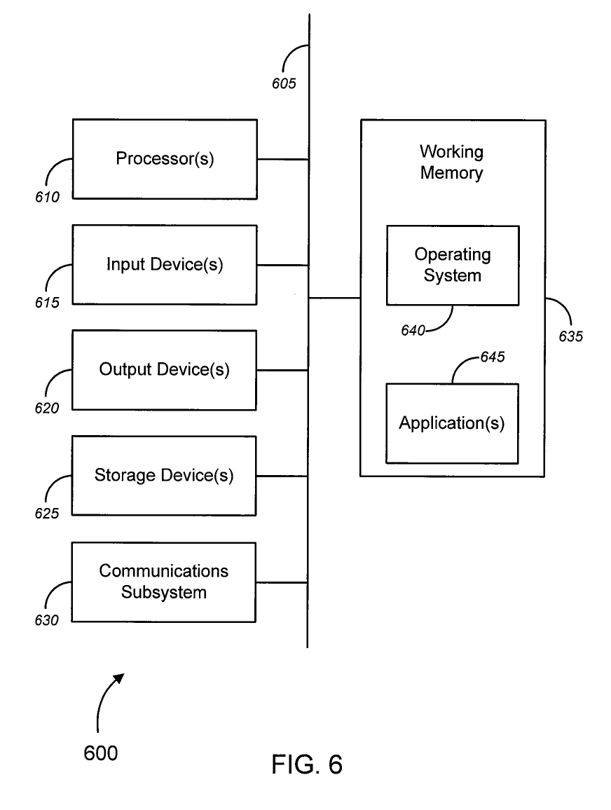

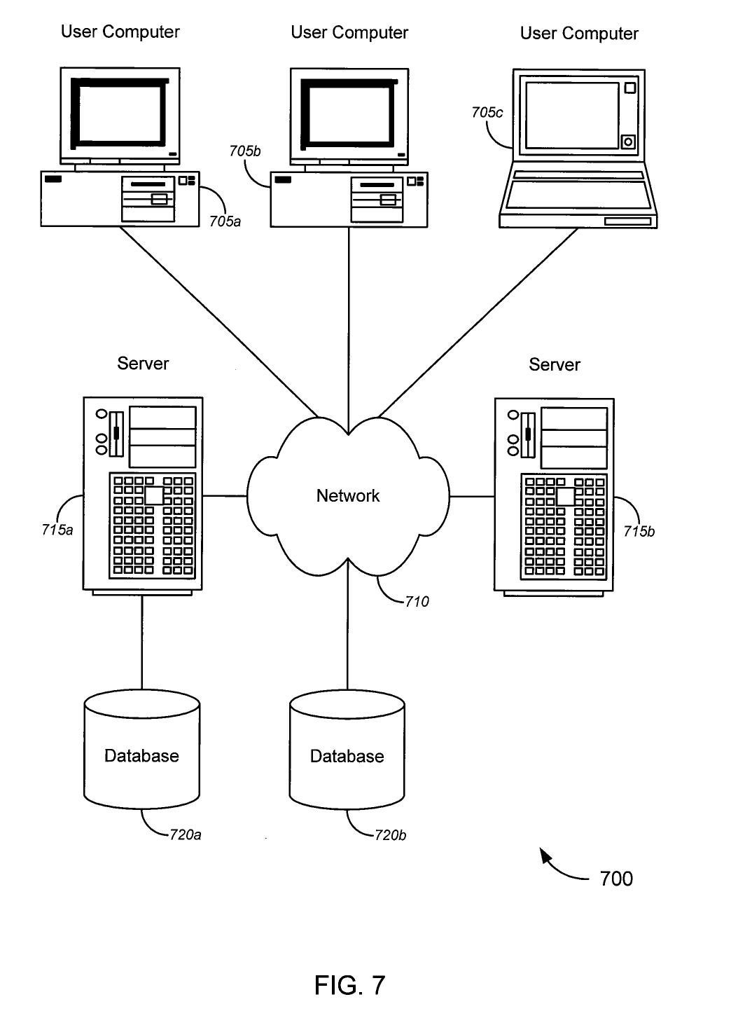

In an aspect, therefore, embodiments of the invention comprises methods of displaying data about credit and/or debit card transactions. In an aspect, the methods may be performed, in whole or in part, by a card issuer or processor. Such methods also may be implemented, in whole or in part by a computer system, such as the computer systems described with respect to FIGS. 6 and 7 below. In another aspect, the methods may be implemented as a computer program (e.g., a set of code and/or instructions that are executable by such a computer system).

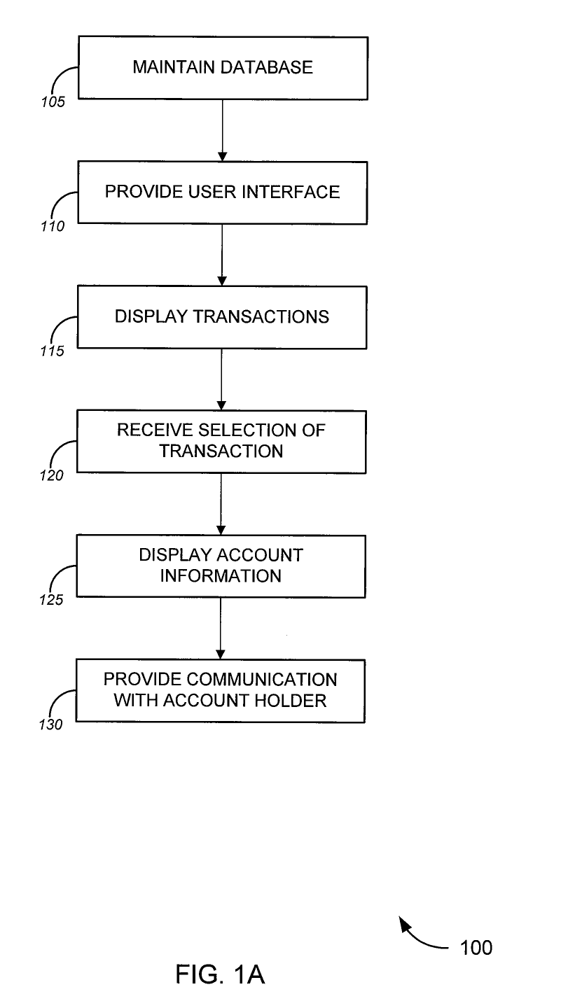

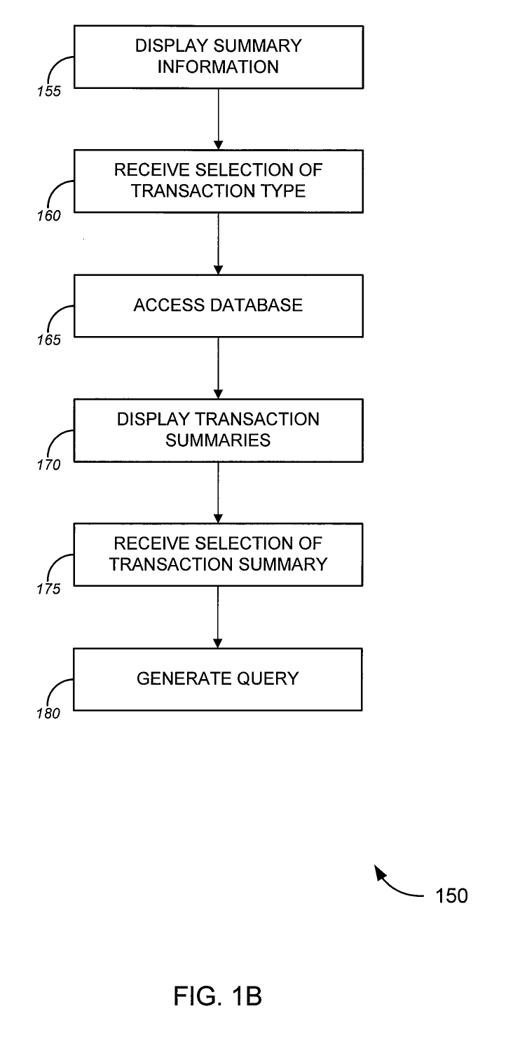

Merely by way of example, FIG. 1A illustrates a method 100 of providing access to data about usage of financial instruments (e.g., credit and/or debit cards), in accordance with one set of embodiments. The method 100 comprises maintaining a database comprising a plurality of records (block 105). Maintaining a database comprises one or more of a variety of activities, such as populating the database with data, providing access to the database, storing the database on a storage medium, updating the database, and/or the like.

The database, which is described in further detail below with respect to FIG. 7, can be any type of database that is used to hold information about financial transactions and/or financial accounts. In particular, the database might comprise one or more tables, such as a table for financial accounts and a table for financial transactions. In some cases, the database is a relational database and/or is maintained by a relational database management system (“RDBMS”). In an aspect, the database comprises a plurality of records. A first set of records (e.g., a first table) might correspond to financial transactions, such that each record in the set of records pertains to a particular transaction involving a particular financial account (such as transactions performed and/or attempted with credit and/or debit cards, to name an example). A second set of records (e.g., a second table) might correspond to financial accounts; each record in this set might pertain to a different financial account and/or might comprise details such as recent activity (perhaps by reference to one or more records in the first set of records, in the case of a relational database), the name and other biographical information (such as address, social security number, etc) of one or more account holders (e.g., cardholders) associated with the account, information about credit limits, account balances (either positive balances, such as in the case of debit card accounts and/or depository accounts, or negative balances, such as in the case of credit card accounts).

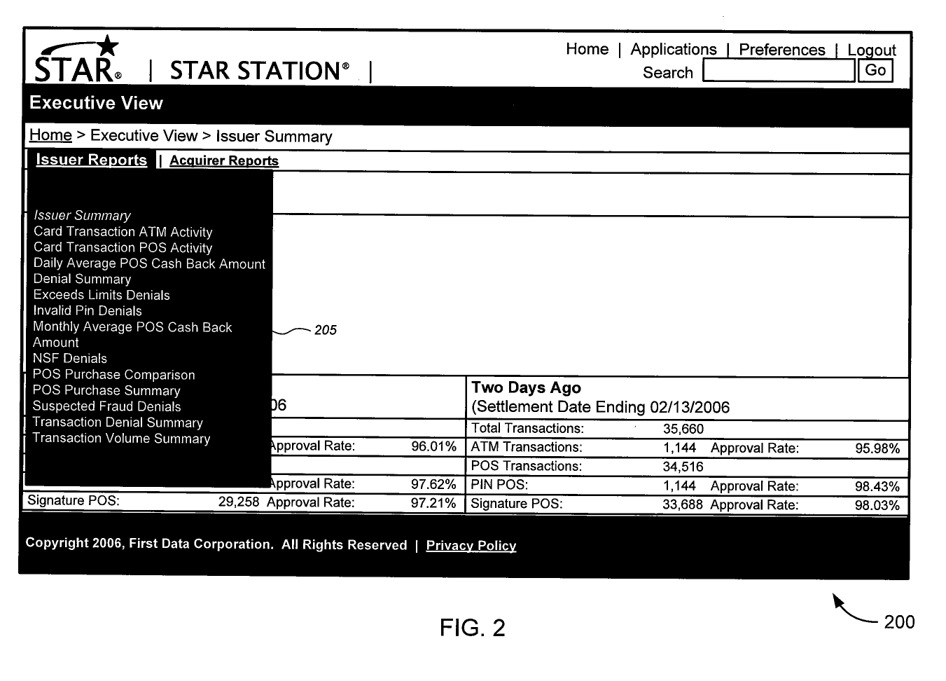

The method further comprises providing a user interface, e.g., for a user to view data about transactions and/or accounts, to receive input from a user, and/or the like, as described in further detail below (block 110). FIGS. 2-5 (described in further detail below) are examples of display screens that may be generated by the user interface. For illustrative purposes, FIGS. 2-5 illustrate screens displaying data about debit cards and/or debit card transactions. As noted above, however, other embodiments can be used to display information about credit card usage and/or data related to other types of financial accounts.

There are a variety of techniques by which a user interface may be provided. Merely by way of example, in some embodiments, a program on a client computer (that is, a computer that is directly accessed by a user, via a keyboard, mouse, monitor, etc.) might execute an application program that provides the user interface, for example, using conventional graphics calls to an operating system and/or display hardware to generate the user interface. Such an application might be configured to access a database (either locally and/or on a server) to obtain the data for display. In other embodiments, a client-server application might be implemented, wherein a server application on a server computer obtains and/or processes the data, and then provides the data to a client application on the client computer, which displays the data with a user interface.

In a particular set of embodiments, the tools described herein are provided as a web application, in which the user interface is provided via a web browser on a client computer. More specifically, the user interface is provided via a series of web pages, which are configured to display data for a user and provide interactivity (such as receiving commands to select certain transactions, filter data, etc.), as described further below. In such embodiments, one or more server computers operates application(s) (which could be traditional compiled application, Java applications and/or servlets, CGI programs, a database applications, and/or the like) either standing alone or in conjunction with components (such as JavaScript, AJAX, Java applets, etc.) operating on the client computer, and which interface with a database to obtain data (as described in further detail below, for example), respond to commands received via the user interface, and generate and/or server web pages to provide the user interface.

In an aspect, embodiments of the invention provide for the display of a variety of different information via the user interface, as described in further detail below. As used herein, the terms “providing for the display” and “providing for a user interface to display” mean performing one or more actions to cause the display of information (in a user interface, as appropriate). In some cases, providing for the display of information simply comprises displaying the information. e.g., via the user interface. In other cases, providing for the display of information might comprise one or more other operations including, without limitation, accessing the database to obtain the data to be displayed (e.g., using search or filter criteria provided by the user), formatting the data for display, communicating with the user interface to cause the display of the data, and/or the like. In embodiments that employ a web interface, providing for the display of information may comprise additional and/or alternative operations, such as transmitting the information to a web server, generating a web page (e.g., a hypertext markup language (“HTML”) document) comprising the information, serving the web page to a web browser on a client computer, and/or displaying the web page in the web browser for review by the user.

In a set of embodiments, the user interface displays information about a selected set of transactions (i.e., some subset of the plurality of transactions about which data is stored in the database) for further review by the user. There are a variety of ways in which the set of transactions can be selected. Merely by way of example, FIG. 1B illustrates a method 150 of selecting transactions about which information is to be displayed. This method 150 (and/or various procedures thereof) can be used to select a set of transactions about which information should be displayed, for example, in accordance with the method 100 (as described in further detail below).

In some embodiments the method 150 comprises providing for the display of a set of summary information about the transactions stored in the database (block 155). Many different types of data can be displayed in a summary display; normally a summary or digest of the data is displayed (e.g., consolidations of various measures of card activity). Merely by way of example, FIG. 2, for example illustrates an exemplary screen display 200 of a user interface; the screen display 200 displays a variety of different types of summary information, including a daily count of a total number of transactions, which can be broken down into a daily count of automated teller machine (“ATM”) and point of sale (“POS”) transactions (which can be further subdivided into personal identification number (“PIN”) transactions—where a PIN is entered by the cardholder as security verification, and signature transactions—where a signature is provided by the cardholder as a security verification). Overall approval rates for each of these types of transactions may be displayed as well.

At block 160, the method 150 comprises receiving (e.g., via the user interface) a selection of a transaction type. The selection of a type of transaction indicates a particular subset of the transactions that the user is interested in viewing. (The term “transaction” is used broadly herein to include both completed transactions and transactions that have been attempted but not completed, such as in the case of denied transactions, which are of particular interest in some cases, as noted above.) A variety of types of transactions are possible, including without limitation, completed ATM transactions, completed POS transactions, cash back transactions, denied transactions (including, inter alia, specific types of denials, such as exceeding limits, invalid PIN, non-sufficient funds (“NSF”), suspected fraud, and the like), etc. In one set of embodiments, a user interface element (such as a menu, dialog box, etc.) is provided to allow the user to select a transaction type. Merely by way of example, the screen display 200 illustrates a menu 205 that can be presented to a user to allow the user to select a transaction type. In an aspect, the user might also be allowed to select period (e.g., day, week, quarter, month, year, etc.) of interest, perhaps using similar user interface elements.

The database is then accessed (block 165) to obtain a set of data about transactions of the selected type (and, optionally, over a selected period of interest). In an embodiment, the selected transaction type and/or period of interest are used as filter criteria in determining which data should be obtained. There are a variety of known ways to access a database to obtain desired data (e.g., using SQL queries, ODBC connections, etc.), and any of such techniques may be used in accordance with various embodiments of the invention.

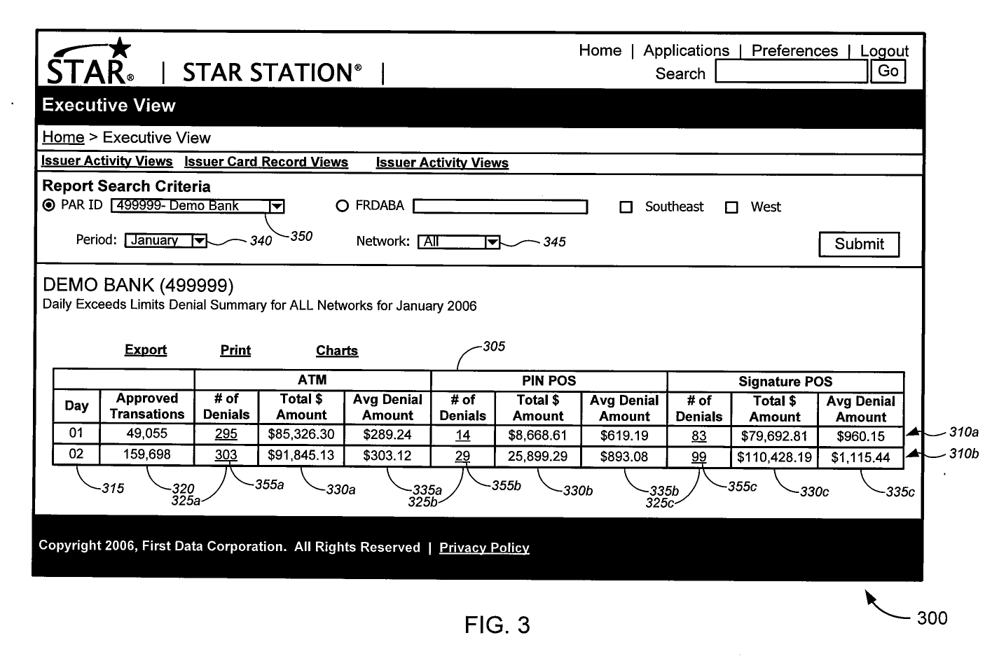

In certain embodiments, the method 150 further comprises providing for the display (e.g, via the user interface) of a set of transaction summaries for the transactions obtained from the database. FIG. 3 illustrates an exemplary screen display 300 that displays a plurality of transaction summaries. In the illustrated example 300, the transactions have been filtered, such that only transactions denials for exceeding daily limit are displayed, and the period of interest is limited to January 2006. In the screen display 300, the transaction summaries are categorized into subperiods (in this embodiment, for example, the subperiods are days of the month). In other embodiments, different categorization criteria may be used, or the transaction summaries might not be categorized at all. For organizational purposes, the transaction summaries are displayed in a table 305 in the screen display 300, although other formats could be used as well. The table 305 has a header row, along with a plurality of rows 30, each corresponding to one of the subperiods of interest. (While, for simplicity's sake, only two rows 310a, 310b are illustrated on FIG. 3, it should be appreciated that a typical display might include any number of such rows, generally corresponding to the number of categories into which the transaction summaries are divided).

The table 305 also comprises a number of columns, including a column 315 that identifies the subperiod (or other categorization criteria) for a transaction summary, a column 320 displaying a number of transactions approved, and, for each of three types of transactions (ATM transactions, PIN POS transactions, and signature POS transactions), columns displaying a number of denials (columns 325a, 325b, 325c, respectively), total amount of denied transactions (columns 330a, 330, 330c, respectively), and average denial amount (columns 335a, 335b, 335c, respectively). Each cell in the table can be considered an intersection of a row and a column, and some or all of the cells might comprise values, indicating a summary of the data for a particular parameter on a particular subperiod.

Because, in the illustrated example, the selected transaction type is “Exceeds Limits Denials” the transaction summaries are limited to transactions of this type. (It should be noted that the content and/or format of the table 305 generally will vary according to the type of transaction selected-for example, if the selected transaction type was not a type of denied transaction, there might not be columns pertaining to denial amounts, etc. Similarly, the nature of the columns in the table 305 might also depend on the type of financial instruments associated with the transactions-credit card transactions typically might not include PIN POS transactions, for example). Hence, the nature of the data displayed by the transaction summaries is typically highly dependent on the nature of the implementation and/or the selections made by the user.

The user interface optionally also comprises additional user interface elements to display for the user (and/or allow the user to modify) the filter criteria used to generate the transaction summaries. Merely by way of example, in some cases, the screen display 300 of FIG. 3 includes a user interface element (in this case, a listbox 340) that allows the user to select a different period of interest. As another example, the database might comprise data for accounts at a number of financial institutions and/or transactions performed via a number of financial processing networks. Hence, the exemplary screen display 300 comprises user interface elements 345 and 350 allowing a user to further filter the data of which the summaries are composed by financial institution and processing network, respectively. Thus, for example, the user might select a particular financial processing network using interface element 345, and the transactions from which the transaction summaries are generated would be limited to transactions processed by that processing network.

At block 175, a selection of a transaction summary is received (e.g., via the user interface). There are many ways in which a transaction summary may be selected. For instance, the user interface might provide a user interface element to allow the user to select one or more transaction summaries. Merely by way of example, the display screen 300 of FIG. 3 illustrates a plurality of transaction summaries, as noted above. In this example, the values in the “# of denials” columns 325 are formatted as hyperlinks (e.g., 355). Hence, by selecting (clicking on) a hyperlink (e.g., 355a) for a particular transaction summary, the user can select that transaction summary.

Based on the selection of a particular transaction summary, a query is generated (block 180) for records relating to transactions summarized by the transaction summary. Merely by way of example, in the screen display 300 of FIG. 3, the transaction summaries are categorized by the date of the transaction. Hence, in accordance with that embodiment, the query would search for records corresponding to the transaction that were used to generate the particular transaction summary. In this case, for example, the query would search for denial transactions (for exceeding daily limits) occurring during a selected subperiod (e.g., in this case, on the date of the selected transaction summary), or in the case that the transaction summaries are not categorized into subperiods, transactions of the selected type that meet the categorization criteria of the transaction summaries. In addition, if the transaction summaries were limited to a particular financial institution and/or processing network, the query would be limited in similar fashion. As noted above, there are a variety of ways in which a database may be queried, and any of those techniques may be used in accordance with various embodiments of the invention. The query produces a set of results, i.e., a set of transaction records corresponding to one or more transactions that meet the query criteria. In this way, for example, the user can select one or more transactions of interest.

Returning to FIG. 1A, he method then may further provide for the display (e.g., via the user interface to display information about one or more transactions of the selected type (block 115). In some cases, this information might comprise a set of query results (e.g., results of a query such as the query described above). For example, as noted above, in an aspect, the results of the query are a set of one or more transactions that meet the query criteria. These results may be displayed as a set of transaction detail entries that each pertain to a transaction that meets the query criteria.

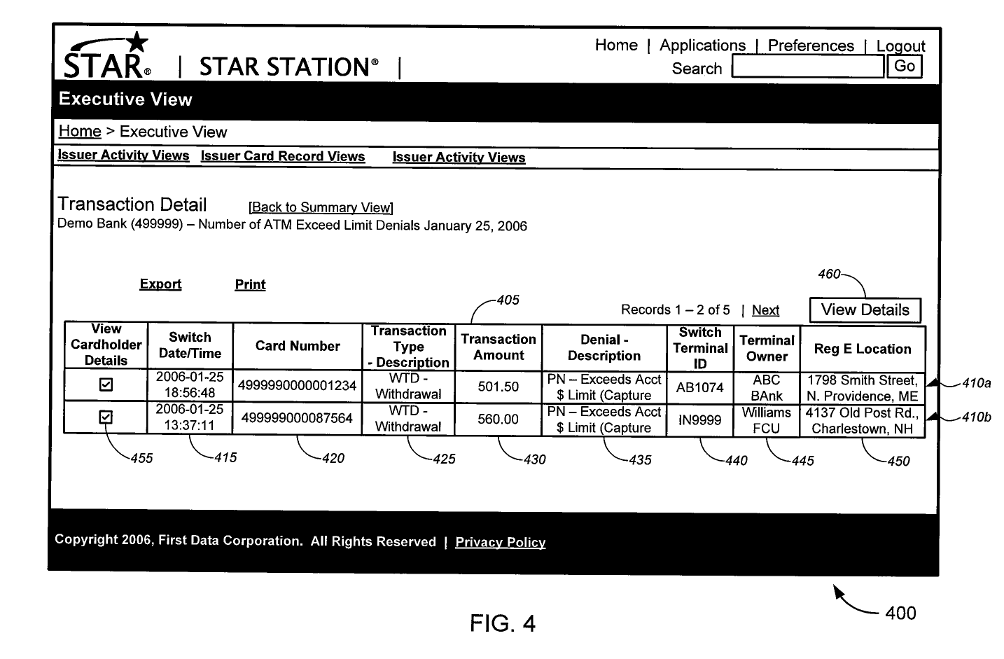

Merely by way of example, FIG. 4 illustrates an exemplary screen display 400 of a set of query results. In this case, the query results are a particular set of transactions (specifically ATM transactions that were denied on Jan. 25, 2006 for exceeding withdrawal limits), each of which is associated with a particular debit card. The screen display 400 comprises a table 405, which, like the table 305 of FIG. 3 comprises a plurality of rows and columns; the intersection of a particular row and a particular column defines a cell, which has a value. In this screen display 405, each row 410 is a transaction detail entry pertaining to a transaction that meets the query criteria. The columns might include, without limitation, a column 415 displaying the date and/or time of the attempted transaction, a column 420 displaying a card number (or other identifier of a financial instrument) associated with the transaction, columns 425, 430 displaying the type and amount, respectively, of the attempted transaction, a column displaying the type of denial and/or reason for denial (which in this case, as noted above, is exceeding limits). There might also be columns 440, 445 and 450 for displaying the terminal ID of the terminal (e.g., ATM, POS terminal, etc.), an owner of the terminal, and/or a location of the terminal, respectively.

At block 120, a selection of one or more transactions of interest is received (e.g., via the user interface). There are many techniques by which such a selection can be made by the user. Merely by way of example, in the screen display of FIG. 4, each of the transactions detail entries (i.e., rows 110 in the table) includes a user interface element (in this case a checkbox 455) to allow the user to select the transaction, and the screen display 400 also includes a user interface element (in this case, a button 460) for the user to effectuate the selection. Hence, the user can select (check) as many transactions as desired, and, by pressing the button 460, indicate to the program, through the user interface, that selections have been made. (In other embodiments, different user interface elements, such as the hyperlinks described above, might be used in addition and/or alternatively to the checkboxes 455 and button 460 illustrated on FIG. 4).

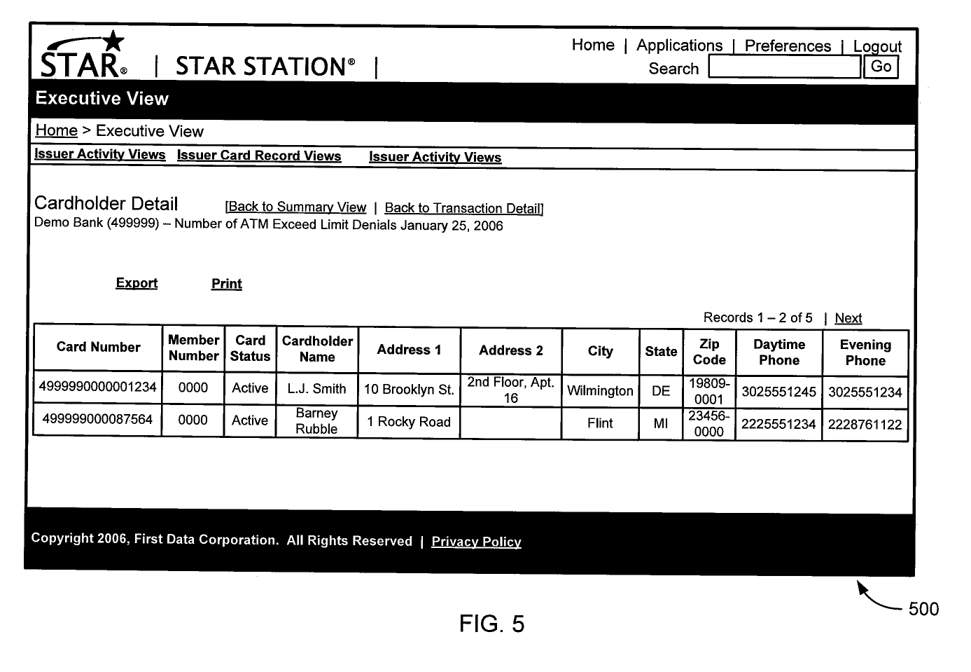

In response to the selection, the computer program provides for the display (e.g., via the user interface) of one or more sets of account information (block 125) about the account(s) corresponding to the selected transaction(s). In an aspect, the account information might include any information stored in the database about the relevant account, such as a card status (e.g., activated, unactivated, captured, etc.); card number, a cardholder name, address, etc.; FIG. 5 illustrates an example screen display 500 that can be used to display such account information.

In some cases, the method 100 comprises providing for communication between the user and the account holder associated with the card account (block 130). For instance, the user interface might include user interface elements (not shown on FIG. 5) that allow the user to send an electronic mail message to the cardholder, create, print and/or send a letter (postal mail) to the cardholder, etc. In some cases, a variety of pre-formatted messages may be available to the user, and/or a particular message format might be pre-selected, based on the type of transaction the user was viewing when the account was selected and/or the current status of the account. For example, if the type of transaction was denial for exceeding daily limits, a pre-formatted message offering to raise spending, credit, and/or withdrawal limits might be selected. As another example, if the user's card is currently inactive, the selected message might remind the account holder to activate the card, extol the benefits of activation, offer to close the account, etc.

Additionally and/or alternatively, the method might include providing for one or more actions to be taken with respect to the account (block 130), again based (perhaps) on the type of transaction selected, the status of the account, and/or the authority of the user. In an aspect, providing for an action to be taken comprises providing tools for the user to initiate the action (e.g., user interface elements for the user to initiate a desired action); in another aspect, the action might be taken automatically without user input. Such actions (which might be triggered by appropriate user interface elements (not shown on FIG. 5), can include, without limitation, raising an account limit governing the account, closing the account, and/or the like. In an embodiments, some or all of such actions can be effectuated by updating data in the database.

FIG. 6 provides a schematic illustration of one embodiment of a computer system 600 that can perform the methods of the invention, as described herein, and/or can function as a client computer, host computer, server, etc. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements can include one or more processors 610, including without limitation one or more general-purpose processors and/or one or more special-purpose processors (such as digital signal processing chips, graphics acceleration chips, and/or the like); one or more input devices 615, which can include without limitation a mouse, a keyboard and/or the like; and one or more output devices 620, which can include without limitation a display device, a printer and/or the like.

The computer system 600 may further include (and/or be in communication with) one or more storage devices 625, which can comprise, without limitation, local and/or network accessible storage and/or can include, without limitation, a disk drive, a drive array, an optical storage device, solid-state storage device such as a random access memory (“RAM”) and/or a read-only memory (“ROM”), which can be programmable, flash-updateable and/or the like. The computer system 600 might also include a communications subsystem 630, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 630 may permit data to be exchanged with a network (such as the network described below, to name one example), and/or any other devices described herein. In many embodiments, the computer system 600 will further comprise a working memory 635, which can include a RAM or ROM device, as described above.

The computer system 600 also can comprise software elements, shown as being currently located within the working memory 635, including an operating system 640 and/or other code, such as one or more application programs 645, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer readable storage medium, such as the storage device(s) 625 described above. In some cases, the storage medium might be incorporated within a computer system, such as the system 600. In other embodiments, the storage medium might be separate from a computer system (i.e., a removable medium, such as a compact disc, etc.), and or provided in an installation package, such that the storage medium can be used to program a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 600) to perform methods of the invention. According to a set of embodiments, some or all of the procedures of such methods are performed by the computer system 600 in response to processor 610 executing one or more sequences of one or more instructions (which might be incorporated into the operating system 640 and/or other code, such as an application program 645) contained in the working memory 635. Such instructions may be read into the working memory 635 from another machine-readable medium, such as one or more of the storage device(s) 625. Merely by way of example, execution of the sequences of instructions contained in the working memory 635 might cause the processor(s) 610 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 600, various machine-readable media might be involved in providing instructions/code to processor(s) 610 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical or magnetic disks, such as the storage device(s) 625. Volatile media includes, without limitation dynamic memory, such as the working memory 635. Transmission media includes coaxial cables, copper wire and fiber optics, including the wires that comprise the bus 605, as well as the various components of the communication subsystem 630 (and/or the media by which the communications subsystem 630 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600. These signals, which might be in the form of electromagnetic signals, acoustic signals, optical signals and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a storage device 625 either before or after execution by the processor(s) 610.

A set of embodiments comprises systems for displaying information for a user. Merely by way of example, FIG. 7 illustrates a schematic diagram of a system 700 that can be used in accordance with one set of embodiments. The system 700 can include one or more user computers 705 (also referred to herein as “client computers”). The user computers 705 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. These user computers 705 can also have any of a variety of applications, including one or more applications configured to perform methods of the invention, as well as one or more office applications, database client and/or server applications, and web browser applications. Alternatively, the user computers 705 can be any other electronic device, such as a thin-client computer, Internet-enabled mobile telephone, and/or personal digital assistant, capable of communicating via a network (e.g., the network 710 described below) and/or displaying and navigating web pages or other types of electronic documents. Although the exemplary system 700 is shown with three user computers 705, any number of user computers can be supported.

Certain embodiments of the invention operate in a networked environment, which can include a network 710. The network 710 can be any type of network familiar to those skilled in the art that can support data communications using any of a variety of commercially-available protocols, including without limitation TCP/IP, SNA, IPX, AppleTalk, and the like. Merely by way of example, the network 710 can be a local area network (“LAN”), including without limitation an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 715. Each of the server computers 715 may be configured with an operating system, including without limitation any of those discussed above, as well as any commercially (or freely) available server operating systems. Each of the servers 715 may also be running one or more applications, which can be configured to provide services to one or more clients 705 and/or other servers 715. In an aspect, a server computer 715 might be a mainframe “host” computer that is capable of processing financial transactions, managing a database of financial transactions and/or accounts, and/or communicating with one or more financial processing networks.

Additionally, one of the servers 715 may be a web server, which can be used, merely by way of example, to process requests for web pages or other electronic documents from user computers 705. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 705 to perform methods of the invention. As alluded to above, for example, a web server might be in communication with a host computer, database server, application server, etc. and/or might be configured to generate and/or serve web pages that provide a user interface in accordance with embodiments of the invention.

The server computers 715, in some embodiments, might include one ore more file and/or application servers, which can include one or more applications accessible by a client running on one or more of the client computers 705 and/or other servers 715. Merely by way of example, the server(s) 715 can be one or more general purpose computers capable of executing programs or scripts in response to the user computers 705 and/or other servers 715, including without limitation web applications (which might, in some cases, be configured to perform methods of the invention). Merely by way of example, a web application can be implemented as one or more scripts or programs written in any suitable programming language, such as Java™, C, C6™ or C++, and/or any scripting language, such as Perl, Python, or TCL, as well as combinations of any programming/scripting languages. The application server(s) can also include database servers, including without limitation those commercially available from Oracle, Microsoft, Sybase™, IBM™ and the like, which can process requests from clients (including, depending on the configuration, database clients, API clients, web browsers, etc.) running on a user computer 705 and/or another server 715. In some embodiments, an application server can create web pages dynamically for displaying the information in accordance with embodiments of the invention, such as to provide a user interface for interaction with a user. Data provided by an application server may be formatted as web pages (comprising HTML, Javascript, etc., for example) and/or may be forwarded to a user computer 705 via a web server (as described above, for example). Similarly, a web server might receive web page requests and/or input data from a user computer 705 and/or forward the web page requests and/or input data to an application server. In some cases a web server may be integrated with an application server.

In accordance with further embodiments, one or more servers 715 can function as a file server and/or can include one or more of the files (e.g., application code, data files, etc.) necessary to implement methods of the invention incorporated by an application running on a user computer 705 and/or another server 715. Alternatively, as those skilled in the art will appreciate, a file server can include all necessary files, allowing such an application to be invoked remotely by a user computer 705 and/or server 715. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 720. As noted above, such databases store financial information, including without limitation information about financial accounts and/or financial transactions. The location of the database(s) 720 is discretionary: merely by way of example, a database 720a might reside on a storage medium local to (and/or resident in) a server 715a (and/or a user computer 705). Alternatively, a database 720b can be remote from any or all of the computers 705, 715, so long as it can be in communication (e.g., via the network 710) with one or more of these. In a particular set of embodiments, a database 720 can reside in a storage-area network (“SAN”) familiar to those skilled in the art. (Likewise, any necessary files for performing the functions attributed to the computers 705, 715 can be stored locally on the respective computer and/or remotely, as appropriate.) In one set of embodiments, the database 735 can be a relational database, such as an Oracle database, that is adapted to store, update, and retrieve data in response to SQL-formatted commands. The database might be controlled and/or maintained by a database server, as described above, for example.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with-or without-certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method of providing access to data about usage of financial instruments, the method comprising:
maintaining a database comprising a plurality of records pertaining to a plurality of transactions involving a plurality of financial card accounts, wherein the plurality of records comprises a first record pertaining to a first transaction involving a first financial card account and a second record pertaining to a second transaction involving a second financial card account;
providing a user interface for a user to view data about the plurality of transactions;
providing for the user interface to display a set of summary information about the plurality of transactions;
receiving, via the user interface, a selection of a type of transaction and a selection of a period of interest;
accessing the database to obtain a set of data about transactions of the selected type over the selected period of interest;
providing for the user interface to display, for the user, a plurality of transaction summaries comprising a first transaction summary and a second transaction summary, the first transaction summary displaying summary data about a first set of transactions occurring within a first subperiod of the selected period of interest, the first transaction summary comprising a plurality of fields that display aggregate data about the first set of transactions;
receiving, via the user interface, a selection of the first transaction summary;
generating, based on the selection of the first transaction summary, a query of the database for records pertaining to transactions of the selected type that occurred within the first subperiod;
providing, in response to the selection of the first transaction summary, for the user interface to display a set of results of the query, wherein the display of the set of results comprises a display of a plurality of transaction detail entries, each of the plurality of transaction detail entries pertaining to one of the transactions in the first plurality of transactions, the plurality of transactions comprising the first transaction;
receiving, via the user interface, a selection of one or more of the transaction detail entries; and
providing for the display, via the user interface and in response to the selection of one or more transaction detail entries, of one or more sets of account information, each set of account information pertaining to a financial card account involved in one of the selected transaction detail entries, the one or more sets of account information comprising a first set of account information about the first financial card account, the first set of account information comprising a card status of the first financial card account and a cardholder name of the first financial card account.

2. The method of claim 1, wherein the first financial card account is associated with a credit card.

3. The method of claim 1, wherein the first financial card account is associated with a debit card.

4. A method of providing access to data about usage of financial instruments, the method comprising:
maintaining a database comprising a plurality of records pertaining to a plurality of transactions involving a plurality of financial accounts, each financial account having associated therewith a financial instrument, wherein the plurality of records comprises a first record pertaining to a first transaction involving a first financial instrument and a second record pertaining to a second transaction involving a second financial instrument;
providing a user interface for a user to view data about the plurality of transactions;
receiving, via the user interface, a selection of a type of transaction;
accessing the database to obtain a set of data for the selected type of transaction;
providing for the user interface to display, for the user, information about one or more transactions of the selected type, the one or more transactions comprising the first transaction;
receiving, via the user interface, a request to view account information about the first transaction;
providing, in response to the selection of one or more transaction detail entries, for the user interface to display a set of account information about the first financial account.

5. The method of claim 4, wherein the first financial instrument is a card selected from the group consisting of a credit card and a debit card.

6. The method of claim 5, wherein providing for the display of a set of account information comprises providing for the display of a card status indicator for the card.

7. The method of claim 4, wherein providing for the display of a set of account information comprises providing for user interface to display a cardholder name for the card.

8. The method of claim 4, wherein the selected type of transaction is an automated teller transaction.

9. The method of claim 4, wherein the selected type of transaction is a point of sale transaction.

10. The method of claim 4, wherein the selected type of transaction is a denied transaction.

11. The method of claim 10, wherein the selected type of transaction is a denial for exceeding a spending or withdrawal limit.

12. The method of claim 10, wherein the selected type of transaction is a denial for use of an invalid personal identification number.

13. The method of claim 10, wherein the selected type of transaction is a denial for non-sufficient funds.

14. The method of claim 10, wherein the selected type of transaction is a denial for suspected fraud.

15. The method of claim 4, wherein providing for the user interface to display information about one or more transactions of the selected type comprises:
providing for the user interface to display, for the user, one or more transaction summaries, the one or more transaction summaries comprising a first transaction summary displaying summary data about a first set of transactions and comprising a plurality of fields that display aggregate data about the first set of transactions, the first set of transactions comprising the first transaction; and
receiving, via the user interface, a selection of the first transaction summary.

16. The method of claim 15, wherein providing for the user interface to display information about one or more transactions further comprises:
generating, based on the selection of the first transaction summary, a query of the database for records pertaining to transactions of the selected type.

17. The method of claim 16, wherein providing for the user interface to display information about the one or more transactions further comprises:
providing, in response to the selection of the first transaction summary, for the user interface to display a set of results of the query, wherein the display of the set of results comprises a display of a plurality of transaction detail entries, each of the plurality of transaction detail entries pertaining to one of the transactions in the first set of transactions; and
receiving, via the user interface, a selection of a transaction detail entry corresponding to the first transaction;
wherein the set of account information is displayed in response to the selection the transaction detail entry.

18. The method of claim 15, further comprising receiving, via the user interface, a selection of a period of interest, wherein the first plurality of transactions occur during the period of interest.

19. The method of claim 18, wherein the one or more transaction summaries are a plurality of transaction summaries comprising the first transaction summary and a second transaction summary.

20. The method of claim 19, wherein the first set of transactions occurred within a first subperiod within the period of interest, and wherein the second transaction summary displays summary data about a second set of transactions of the selected type that occurred within a second subperiod within the period of interest.

21. The method of claim 15, wherein the plurality of transactions are performed using a plurality of financial processing networks, the method further comprising:
receiving, via the user interface, a selection of a first financial processing network;
wherein the first set of transactions is limited to transactions processed by the first financial processing network.

22. The method of claim 4, wherein providing a user interface comprises providing a web interface.

23. The method of claim 4, further comprising providing for communication between the user and an account holder associated with the first financial account.

24. The method of claim 23, wherein providing for communication comprises providing for the user to send an electronic mail message to the account holder.

25. The method of claim 23, wherein providing communication comprises providing for the user to send postal mail to the account holder.

26. The method of claim 4, further comprising providing for one or more actions to be taken with respect to the first financial account.

27. The method of claim 26, wherein the one or more actions comprise raising an account limit governing the first financial account.

28. The method of claim 26, wherein the one or more actions comprise closing the first financial account.

29. A system for providing access to data about usage of financial instruments, the system comprising:
a database comprising a plurality of records pertaining to a plurality of transactions involving a plurality of financial accounts, each financial account having associated therewith a financial instrument, wherein the plurality of records comprises a first record pertaining to a first transaction involving a first financial instrument and a second record pertaining to a second transaction involving a second financial instrument;
one or more processors in communication with the database; and
a computer readable storage medium having encoded thereon a computer program, the computer program comprising a set of instructions executable by the processor to perform a set of operations, the set of instructions comprising:
instructions for providing a user interface for a user to view data about the plurality of transactions;
instructions for receiving, via the user interface, a selection of a type of transaction;
instructions for accessing the database to obtain a set of data for the selected type of transaction;
instructions for providing for the user interface to display, for the user, information about one or more transactions of the selected type, the one or more transactions comprising the first transaction;
instructions for receiving, via the user interface, a request to view additional detail about the first transaction; and
instructions for providing, in response to the selection of one or more transaction detail entries, for the user interface to display a set of account information about the first financial account.

30. The system of claim 29, further comprising a web server, wherein the instructions for providing a user interface comprise instructions for causing the web server to transmit a set of one or more web pages, the set of one or more web pages comprising the user interface.

31. A computer readable storage medium having encoded thereon a computer program, the computer program comprising a set of instructions executable by a computer system to perform a set of operations, the set of instructions comprising:
instructions for providing a user interface for a user to view data about the plurality of transactions;
instructions for receiving, via the user interface, a selection of a type of transaction;
instructions for accessing the database to obtain a set of data for the selected type of transaction;
instructions for providing for the user interface to display, for the user, information about one or more transactions of the selected type, the one or more transactions comprising the first transaction;
instructions for receiving, via the user interface, a request to view additional detail about the first transaction; and
instructions for providing, in response to the selection of one or more transaction detail entries, for the user interface to display a set of account information about the first financial account.
